(19) United States
(12) Patent Application Publication
(10) Pub. No.: US 2016/0049709 A1
(43) Pub. Date: Feb. 18, 2016

(54) PHASE SHIFTER, ANTENNA AND RADIO APPARATUS

(71) Applicant: NIHON DENGYO KOSAKU CO., LTD., Chiyoda-ku, Tokyo (JP)

(72) Inventors: Masahiro KARIKOMI, Tokyo (JP); Takashi NISHIMURA, Tokyo (JP); Yoshiro UTSUGI, Tokyo (JP); Ryohei NAKAJIMA, Tokyo (JP)

(73) Assignee: NIHON DENGYO KOSAKU CO., LTD., Chiyoda-ku, Tokyo (JP)

(21) Appl. No.: 14/779,687

(22) PCT Filed: Mar. 18, 2014
(86) PCT No.: PCT/JP2014/057352

§ 371 Date: Sep. 24, 2015

(30) Foreign Application Priority Data
Mar. 29, 2013 (JP) 2013-071364

(51) Int. Cl. H01P 1/18; H01Q 3/34

(52) U.S. Cl. CPC H01P 1/184; H01Q 3/34

(57) ABSTRACT

A phase shifter, which reduces the loss of transmission/reception signals, includes: a linear conductor (211); a conductor (212) curved to form an arc of a radius Ro; and a conductor (214) that has a curving portion (214a) curved to form an arc of a radius Ri, and that also has an extending portion (214b) linearly extending from one end of the curving portion (214a). The phase (phase shift amount) varies depending on the rotation of the conductor (214) about a rotation axis (220) which causes the position of a part (α) where the curving portion (214a) overlaps the conductor (211) to move along the curving portion (214a) and the position of a part (β) where the extending portion (214b) overlaps the conductor (212) to move along the conductor (212).

### TECHNICAL FIELD

The present invention relates to a phase shifter, an antenna and a radio apparatus.

### BACKGROUND ART

An array antenna in which antenna elements such as dipole antennas are arrayed is typically used as an antenna (base-station antenna) for a mobile communication base station. The radiation pattern of the array antenna is set by a phase shifter controlling phases of input signals to be input to the antenna elements of the array antenna or phases of output signals received by the antenna elements.

Patent document 1 describes a variable phase shifter which includes a housing, a fixed board fixedly provided within the housing, receiving an input signal through a first transfer stripline provided on one surface thereof, which is a micro stripline formed with an open end, and having at least one arc-shaped output micro stripline outside the first transfer stripline, and a rotating board rotatably provided within the housing while coming in contact with the one surface of the fixed board, and having a second transfer stripline on a surface where the rotating board comes in contact with the one surface of the fixed board, and in which coupling between the striplines is made and thus at least one output signal is provided even when the rotating board rotates.

### CITATION LIST

### Patent Literature

Patent Document 1: Japanese Unexamined Patent Application Publication (Translation of PCT Application) No. 2009-542155

### SUMMARY OF INVENTION

### Technical Problem

An object of the present invention is to provide a phase shifter or the like in which loss of a transmission/reception signal is reduced.

### Solution to Problem

To attain the above object, there is provided a phase shifter to which this invention is applied including: a first conductor that has a first curvature radius, that has one end connected to a first input-output terminal, and that is made of a conductive material; a second conductor that includes a curving portion of a second curvature radius smaller than the first curvature radius, and an extending portion extending from one end of the curving portion so as to be electrically coupled to the first conductor, that has a position relatively movable in the first conductor, the position being electrically coupled to the first conductor, and that is made of a conductive material; and a third conductor that extends to have one end connected to a second input-output terminal and the other end electrically coupled to the curving portion of the second conductor, that has a position relatively movable in the curving portion, the position being electrically coupled to the second conductor, and that is made of a conductive material.

In the phase shifter, moving distance of the position where the first conductor and the extending portion of the second conductor are electrically coupled to each other in the first conductor and moving distance of the position where the curving portion of the second conductor and the third conductor are electrically coupled to each other in the curving portion of the second conductor are set to have a predetermined ratio.

Further, the first curvature radius and the second curvature radius are provided for a common center.

Furthermore, the phase shifter further includes a first plate member and a second plate member each of which is made of a conductive material. The first conductor, the second conductor, and the third conductor are provided between the first plate member and the second plate member.

Still furthermore, any one of electrical coupling between the first conductor and the extending portion of the second conductor and electrical coupling between the curving portion of the second conductor and the third conductor is capacitive coupling where any one of a dielectric layer and air layer is interposed.

From another standpoint, there is provided an antenna to which this invention is applied including: plural antenna elements; and a phase shifter including a first conductor that has a first curvature radius, that has one end connected to a first input-output terminal, and that is made of a conductive material, a second conductor that includes a curving portion of a second curvature radius smaller than the first curvature radius and an extending portion extending from one end of the curving portion so as to be electrically coupled to the first conductor, that has a position relatively movable in the first conductor, the position being electrically coupled to the first conductor, and that is made of a conductive material, and a third conductor that extends to have one end connected to a second input-output terminal and the other end electrically coupled to the curving portion of the second conductor, that has a position relatively movable in the curving portion, the position being electrically coupled to the second conductor, and that is made of a conductive material, the first input-output terminal being connected to any of the plural antenna elements.

The antenna further includes a divider connected to the second input-output terminal and dividing a transmission/reception signal.

From further standpoint, there is provided a radio apparatus including: plural antenna elements; a phase shifter including a first conductor that has a first curvature radius, that has one end connected to a first input-output terminal, and that is made of a conductive material, a second conductor that includes a curving portion of a second curvature radius smaller than the first curvature radius, and an extending portion extending from one end of the curving portion so as to be electrically coupled to the first conductor, that has a position relatively movable in the first conductor, the position being electrically coupled to the first conductor, and that is made of a conductive material, and a third conductor that extends to have one end connected to a second input-output terminal and the other end electrically coupled to the curving portion of the second conductor, that has a position relatively movable in the curving portion, the position being electrically coupled to the second conductor, and that is made of a conductive material, the first input-output terminal being connected to any of the plural antenna elements; and a transceiver unit that transmits, to the second input-output terminal, a transmission signal for enabling an antenna element connected to the first input-output terminal out of the plural antenna elements to transmit radio frequencies, and that receives, from the second input-output terminal, a reception signal converted from radio frequencies received by the antenna element.

### Advantageous Effects of Invention

According to the present invention, it is possible to provide a phase shifter or the like in which loss of a transmission/reception signal is reduced.

### BRIEF DESCRIPTION OF DRAWINGS

FIG. 1 is diagrams illustrating one example of an entire configuration of a base-station antenna for mobile communication to which the first exemplary embodiment is applied. FIG. 1A is a perspective view of the base-station antenna, and FIG. 1B is a diagram illustrating one example of installation of the base-station antenna.

FIG. 2 is a diagram illustrating one example of a configuration of a sector antenna in the first exemplary embodiment.

FIG. 3 is a diagram showing the relation of the connections between the array antenna, the phase shifter, and the divider.

FIG. 4 is a diagram illustrating an overview of the phase shifter in the first exemplary embodiment.

FIG. 5 is diagrams illustrating the inside of the phase shifter in the first exemplary embodiment. FIG. 5A is a view illustrating the phase shifter where the plate member has been removed, and FIG. 5B is a view illustrating a cross section taken along a line VB-VB of FIG. 5A.

FIG. 6 is diagrams illustrating the conductors taken from the phase shifter. FIG. 6A shows the fixed conductors, and FIG. 6B shows the rotatable conductor.

FIG. 7 is diagrams for describing the phase shift amount of the phase shifter in the case where the radius Ri:the radius Ro is 1:3. FIG. 7A shows the equivalent circuit of the phase shifter, and FIG. 7B is a table showing the phase shift amount.

FIG. 8 is a diagram showing the relation of the connection between the array antenna and the phase shifter.

FIG. 9 is diagrams for describing the phase shift amount of the phase shifter in the case of the radius Ri:the radius Ro=1:2. FIG. 9A shows the equivalent circuit of the phase shifter 200, and FIG. 9B is a table showing the phase shift amount.

FIG. 10 is a diagram illustrating the inside of the phase shifter in the second exemplary embodiment.

FIG. 11 is a diagram illustrating one example of the configuration of the omni antenna in the third exemplary embodiment.

### DESCRIPTION OF EMBODIMENTS

Hereinafter, exemplary embodiments of the present invention will be described in detail with reference to attached drawings.

### First Exemplary Embodiment

### Base-Station Antenna 1

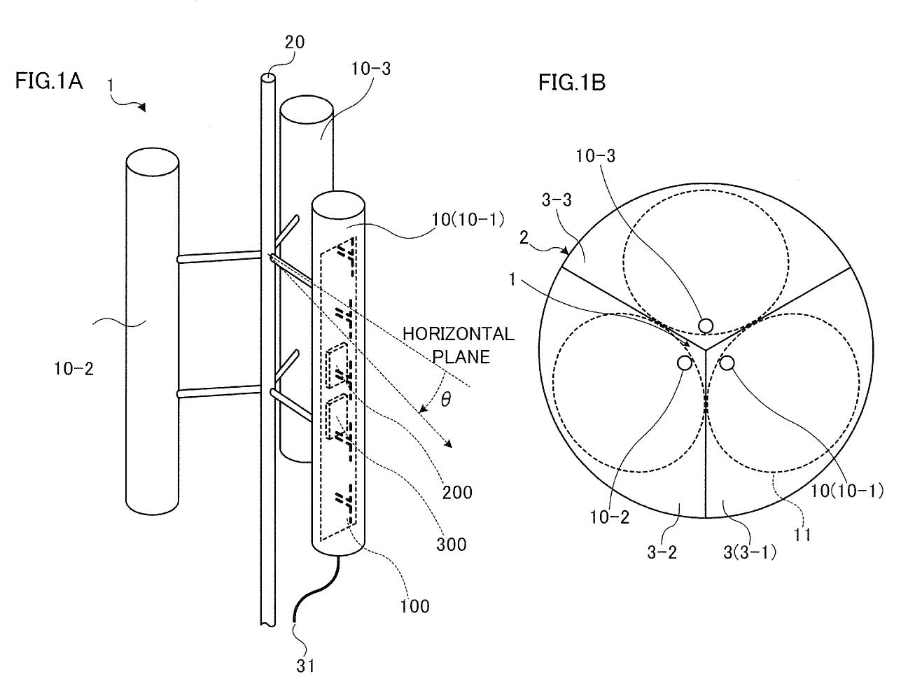

FIG. 1 is diagrams illustrating one example of an entire configuration of a base-station antenna 1 for mobile communication to which the first exemplary embodiment is applied. FIG. 1A is a perspective view of the base-station antenna 1, and FIG. 1B is a diagram illustrating one example of installation of the base-station antenna 1.

The base-station antenna 1 includes, for example, plural sector antennas 10-1 to 10-3 held by a tower 20, as shown in FIG. 1A. The base-station antenna 1 enables radio frequencies to reach an area within a cell 2, as shown in FIG. 1B. In other words, the cell 2 shows a reachable range of the radio frequencies from the base station antenna 1.

Each of the sector antennas 10-1 to 10-3 has an outer shape formed into a cylinder, and the center axis of the cylinder is configured to be vertical towards the ground.

As shown in FIG. 1B, the cell 2 includes plural sectors 3-1 to 3-3 into which the horizontal plane of the cell 2 is divided by an angle. The sectors 3-1 to 3-3 are provided so as to correspond to the three sector antennas 10-1 to 10-3 of the base station antenna 1, respectively. That is, the direction of a main lobe 11 of each of the sector antennas 10-1 to 10-3, where the electric field of the output electric waves is large, points toward corresponding one of the sectors 3-1 to 3-3.

Here, in the case where the sector antennas 10-1 to 10-3 are not discriminated from each other, they are expressed as the sector antennas 10. In the case where the sectors 3-1 to 3-3 are not discriminated from each other, they are expressed as the sectors 3.

Note that, the base-station antenna 1 shown as one example in FIG. 1 includes the three sector antennas 10-1 to 10-3 which correspond to the sectors 3-1 to 3-3, respectively. However, the number of the sector antennas 10 and the number of the sectors 3 may be a predetermined number other than three. Although the sectors 3 are configured by equally dividing the cell 2 in FIG. 1A, the cell 2 may be unequally divided, and any one of the sectors 3 may be wider or narrower than the other sectors 3.

Note that, hereinafter, the case where the base-station antenna 1 transmits radio frequencies will be mainly described. However, because of reversibility of the antenna, the base-station antenna 1 receives radio frequencies. The case where radio frequencies are received may be estimated by replacing the transmission signals with the reception signals and reversing flow of the signal, for example.

Each of the sector antennas 10 includes an array antenna 100, a phase shifter 200, and a divider 300. Note that the sector antenna 10 may be expressed as an antenna in some cases.

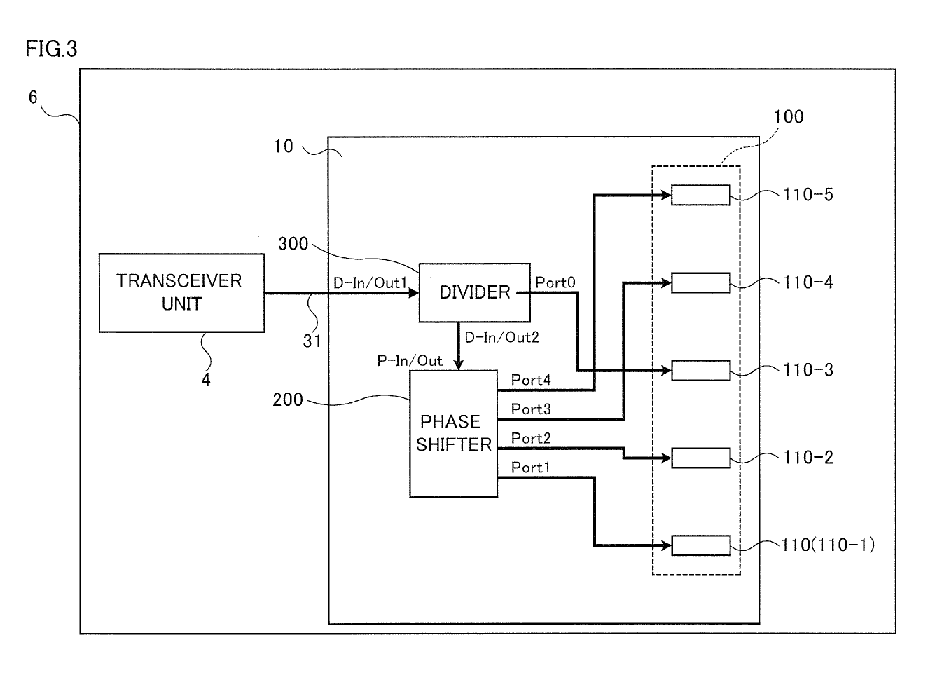

The phase shifter 200 outputs the transmission signal input to, for example, an input-output terminal (refer to P-In/Out shown in later-described FIG. 3) after the phase of the transmission signal is shifted so as to be different between at least two input-output terminals (refer to a port 1 to a port 4 shown in later described FIG. 3).

The divider 300 divides (outputs) the transmission signal for transmitting radio frequencies, which has been input to, for example, the input-output terminal (refer to D-In/Out1 shown in later-described FIG. 3), between (to) plural input-output terminals (refer to D-In/Out 2 and a port 0 in later-described FIG. 3), after impedance matching.

Each of the sector antennas 10 is connected to a transmitting and receiving cable 31 through which transmission signals to the divider 300 and reception signals from the divider 300 pass.

The transmitting and receiving cable 31 is connected to a transceiver unit 4 (refer to later-described FIG. 3) that is provided in the base station (not shown), that transmits transmission signals, and that receives reception signals. The transmitting and receiving cable 31 is, for example, a coaxial cable.

In FIG. 1A, the array antenna 100, the phase shifter 200, the divider 300, and the transmitting and receiving cable 31 are shown in the sector antenna 10-1. The array antenna 100, the phase shifter 200, the divider 300, and the transmitting and receiving cable 31 are provided in the other sector antennas 10-2 and 10-3 similarly to the sector antenna 10-1, but the illustration thereof is omitted.

Note that the description of the array antenna 100, the phase shifter 200, and the divider 300 will be given later.

The base-station antenna 1 is preferably configured to transmit radio frequencies within the cell 2 and not to transmit radio frequencies within another cell outside and adjacent to the cell 2. Also, the base-station antenna 1 is preferably configured to receive radio frequencies within the cell 2, and not to receive radio frequencies from another cell outside and adjacent to the cell 2.

Thus, as shown in FIG. 1A, the transmitting and receiving direction (radiation pattern) of radio frequencies (beams) is tilted toward the ground direction at an angle θ (beam tilt angle θ) towards the horizontal plane.

### <Sector Antenna 10>

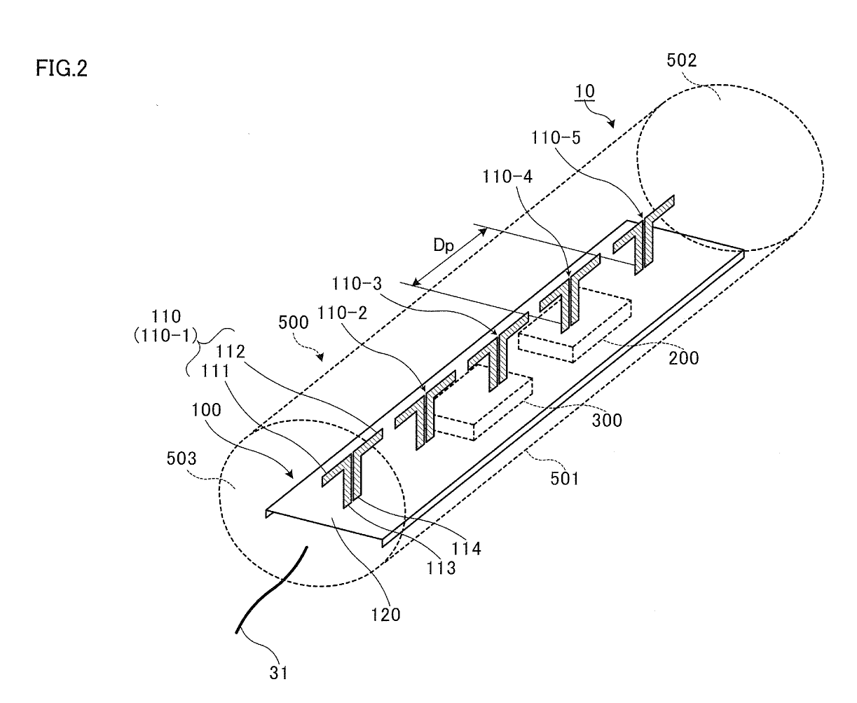

FIG. 2 is a diagram illustrating one example of a configuration of the sector antenna 10 in the first exemplary embodiment. FIG. 2 is a perspective view of the one sector antenna 10 that has been laid.

The sector antenna 10 includes a reflector 120, the array antenna 100 including plural antenna elements arrayed on the reflector 120, the phase shifter 200, the divider 300, and a radome 500. Note that the radome 500 is provided so as to surround the array antenna 100, the reflector 120, the phase shifter 200, and the divider 300. In FIG. 2, the radome 500 is represented with broken lines, so that the array antenna 100 and the like provided inside the radome 500 can be seen. The phase shifter 200 and the divider 300 are also represented with broken lines because they are disposed on the rear surface of the array antenna 100.

Hereinafter, description will be given in a case where dipole antennas are used as one example of the antenna elements.

The array antenna 100 includes dipole antennas 110-1 to 110-5. In the case where the dipole antennas 110-1 to 110-5 are not discriminated from each other, they are expressed as the dipole antennas 110.

Each of the dipole antennas 110 includes linear elements 111 and 112 aligned in a straight line.

Further, a conductive portion 113 having one end connected to the element 111 and the other end connected to the later-described reflector 120 and a conductive portion 114 having one end connected to the element 112 and the other end connected to the reflector 120 in a similar manner are provided at a section where the element 111 and the element 112 of the dipole antenna 110 face each other.

Each of the elements 111 and 112 and the conductive portions 113 and 114 is made of a conductor such as copper or aluminum on a front-surface side of a dielectric substrate (not shown) such as an epoxy resin.

The dipole antenna 110 shown in FIG. 2 can transmit and receive polarizations (vertical polarization) having an electric field oscillating in a vertical direction towards the ground. Note that polarizations (horizontal polarization) having an electric field oscillating in a parallel direction towards the ground may be transmitted and received by aligning the elements 111 and 112 parallel to the ground. Alternatively, the array antenna 100 may transmit and receive both of the vertical polarization and the horizontal polarization by alternately or crosswise disposing the dipole antennas 110 receiving the vertical polarization and dipole antennas receiving the horizontal polarization.

The reflector 120 reflects the radio frequencies transmitted from the dipole antennas 110, and holds the dipole antennas 110. In FIG. 2, the five dipole antennas 110 are disposed on the reflector 120 at intervals Dp.

The part of the reflector 120, which faces the dipole antennas 110, is flat, and both ends of the reflector 120 are bent toward one side opposite to the side where the dipole antennas 110 are provided. Note that the both ends may not be bent, or may be bent toward the side where the dipole antennas 110 are disposed.

The reflector 120 is made of a conductor, for example, aluminum or copper.

In FIG. 2, the reflector 120 is provided so as to be shared by the five dipole antennas 110-1 to 110-5. However, the reflector 120 may be divided into pieces corresponding to the dipole antennas 110.

The radome 500 includes a cylinder 501, an upper lid 502 covering the upper end of the cylinder 501, and a lower lid 503 covering the lower end of the cylinder 501. The array antenna 100, the phase shifter 200, and the divider 300 are contained in the radome 500.

In the lower lid 503 of the radome 500, a connector (not shown) to which the transmitting and receiving cable 31 for passing through transmission signals and reception signals to/from the divider 300 is connected is provided.

The radome 500 is made of an insulating resin such as FRP (fiber reinforced plastics).

Note that the array antenna 100 of the sector antenna 10 shown in FIG. 2 contains the five dipole antennas 110. However, the number of the dipole antennas 110 is not limited to five, and may be a predetermined number.

The sector antenna 10 shown in FIG. 2 contains the one array antenna 100 including the five dipole antennas 110. However, the sector antenna 10 may contains plural array antennas 100 arranged therein.

Further, in FIG. 2, the radome 500 covering the array antenna 100 and the like is formed of the cylinder 501 having the upper lid 502 and the lower lid 503, but may be a tube having a cross section of a rectangle or a rectangle-like shape having one side formed into an arc.

In FIG. 2, illustration of the connections between the phase shifter 200, the divider 300, and the dipole antennas 110 is omitted.

### <Relation of the Connections Between the Array Antenna 100, the Phase Shifter 200, and the Divider 300>

FIG. 3 is a diagram showing the relation of the connections between the array antenna 100, the phase shifter 200, and the divider 300.

Here, the description will be given on the assumption that the array antenna 100 includes the five dipole antennas 110 (110-1, 110-2, . . . , and 110-5).

The phase shifter 200 includes the P-In/Out and the port 1 to the port 4, which are five input-output terminals. Each of the port 1 to the port 4 is one example of a first input-output terminal, and the P-In/Out is one example of a second input-output terminal.

The P-In/Out of the phase shifter 200 is connected to the D-In/Out2 as an input-output terminal of the later-described divider 300. The port 1 is connected to the dipole antenna 110-1, the port 2 is connected to the dipole antenna 110-2, the port 3 is connected to the dipole antenna 110-4, and the port 4 is connected to the dipole antenna 110-5. Note that the dipole antenna 110-3 is connected to the port 0 of the divider 300, and is not connected to the phase shifter 200, as described later.

In the case where the array antenna 100 transmits radio frequencies, the port 1 to the port 4 of the phase shifter 200 output signals obtained by shifting the phase of the transmission signal input to the P-In/Out.

In the case where the array antenna 100 receives radio frequencies, the P-In/Out outputs a signal obtained by synthesizing the reception signals input to the respective ports 1 to 4 after the phases of the reception signals are shifted.

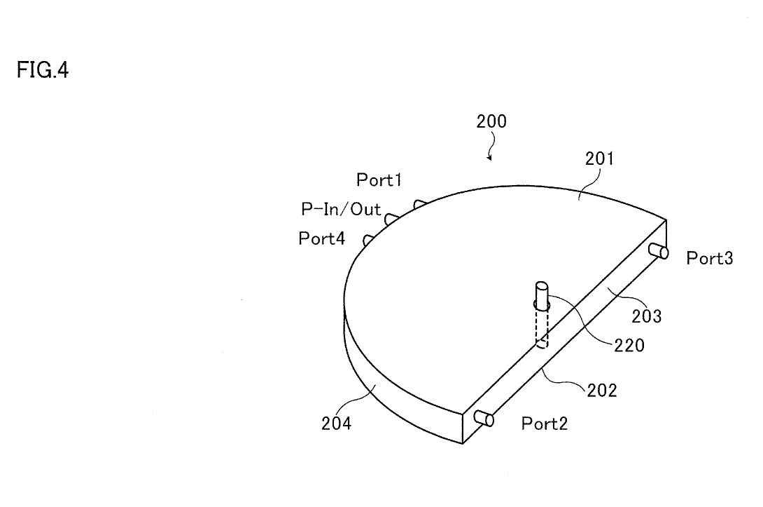

Note that the amount of the shifted phase (phase shift amount) is variable by using a rotation axis 220 (refer to FIG. 4) provided in the phase shifter 200.

The divider 300 includes the D-In/Out1, the D-In/Out2, and the port 0, which are input-output terminals. The D-In/Out1 of the divider 300 is connected to the transceiver unit 4 through the transmitting and receiving cable 31. The port 0 of the divider 300 is connected to the dipole antenna 110-3, and the D-In/Out2 is connected to the P-In/Out of the phase shifter 200.

In the case where the array antenna 100 transmits radio frequencies, the divider 300 divides, between the port 0 and the D-In/Out2, the transmission signal which has been input to the D-In/Out1 from the transceiver unit 4 through the transmitting and receiving cable 31, and outputs the transmission signal to the port 0 and the D-In/Out2, while the impedance is matched.

In the case where the array antenna 100 receives radio frequencies, the reception signals that have been input to the port 0 and the D-In/Out2 of the divider 300 are synthesized, and the resultant signal is output from the D-In/Out1 to the transceiver unit 4 through the transmitting and receiving cable 31.

Next, the behavior of the phase shifter 200 and the divider 300 will be described. Here, the case where radio frequencies are transmitted from the sector antenna 10 will be described. The case where the sector antenna 10 receives radio frequencies is estimated by reversing the flow direction of signals due to reversibility of the antenna.

The transmission signal transmitted from the transceiver unit 4 is input to the D-In/Out1 of the divider 300 through the transmitting and receiving cable 31. Then, the transmission signal is divided in the divider 300, and the divided signals are output from the D-In/Out2 and the port 0.

Further, the transmission signal output from the port 0 is input to the dipole antenna 110-3, and the transmission signal output from the D-In/Out2 is input to the P-In/Out of the phase shifter 200.

Here, the phase of the transmission signal output from the port 0 is regarded as a standard, and the phase shift amount thereof is set at “zero.”

The phase shifter 200 outputs, for example, the transmission signal that has the phase shift amount of −4φ from the port 1, the transmission signal that has the phase shift amount of −2φ from the port 2, the transmission signal that has the phase shift amount of +2φ from the port 3, and the transmission signal that has the phase shift amount of +4φ from the port 4, with reference to the transmission signal output from the port 0 (phase shift amount=zero). Here, φ is the predetermined phase shift amount.

The port 1 is connected to the dipole antenna 110-1, the port 2 is connected to the dipole antenna 110-2, the port 3 is connected to the dipole antenna 110-4, and the port 4 is connected to the dipole antenna 110-5. Thus, the transmission signals transmitted to the dipole antennas 110-1 to 110-5 including the dipole antenna 110-3 connected to the port 0 of the divider 300 have the respective phase shift amounts of −4φ, −2φ, zero, +2φ, and +4φ. In other words, the difference between the phase shift amounts of the transmission signals transmitted to the respective dipole antennas 110 is 2φ.

As mentioned above, the dipole antennas 110-1 to 110-5 are aligned at the certain intervals Dp in the array antenna 100. Thus, since the difference between the phase shift amounts is 2φ, the radiation pattern (beam tilt angle θ in FIG. 1) of the radio frequencies to be output can be obtained by using the interval Dp and 2φ as the difference between the phase shift amounts.

In other words, if the array antenna 100 contains the plural dipole antennas 110 aligned at the certain intervals Dp, the radiation pattern of the array antenna 100 is controllable by setting the difference between the phase shift amounts of the transmission signals transmitted to the dipole antennas 110 adjacent to each other at a predetermined value.

Note that the sector antenna 10 herein includes at least the array antenna 100 and the phase shifter 200. Here, a radio apparatus 6 is assumed to include at least the sector antenna 10 and the transceiver unit 4.

Note that, in FIG. 3, each of the ports 1 to 4 of the phase shifter 200 and the port 0 of the divider 300 is connected to corresponding one of the dipole antennas 110. However, each of the ports 1 to 4 of the phase shifter 200 and the port 0 of the divider 300 may be connected to a corresponding one of groups each of which contains the plural dipole antennas 110. In this case, the dipole antennas 110-1 to 110-5 in FIG. 3 may be replaced with groups of the dipole antennas 110.

### <Phase Shifter 200>

Next, the detailed description will be given for the phase shifter 200.

FIG. 4 is a diagram illustrating an overview of the phase shifter 200 in the first exemplary embodiment.

The phase shifter 200 includes plate members 201 and 202 each of which is formed into, for example, a semicircle. The plate members 201 and 202 are spaced at a predetermined interval. Further, the phase shifter 200 includes a side-surface member 203 connected to the straight parts of the plate members 201 and 202, and a side-surface member 204 connected to the arc parts of the semicircles of the plate members 201 and 202. The plate member 201 is one example of the first plate member, and the plate member 202 is one example of the second plate member.

Further, the phase shifter 200 includes the port 2 and the port 3 which are provided on the side-surface member 203, and the P-In/Out, the port 1, and the port 4 which are provided on the side-surface member 204. Although the P-In/Out, the port 1, the port 2, the port 3, and the port 4 are provided on the side-surface member 203 or the side-surface member 204, some or all of them may be provided on the plate member 201 or 202.

The plate members 201 and 202 and the side-surface members 203 and 204 of the phase shifter 200 are made of a conductive material such as copper or aluminum.

The plate members 201 and 202 and the side-surface members 203 and 204 of the phase shifter 200 have the same electric potential.

The interval between the plate members 201 and 202 is, for example, 10 mm.

Further, the phase shifter 200 includes the rotation axis 220 projecting from a hole in the plate member 201.

Here, each of the plate members 201 and 202 of the phase shifter 200 is formed into a semicircle. However, the shape may be a rectangle or another shape.

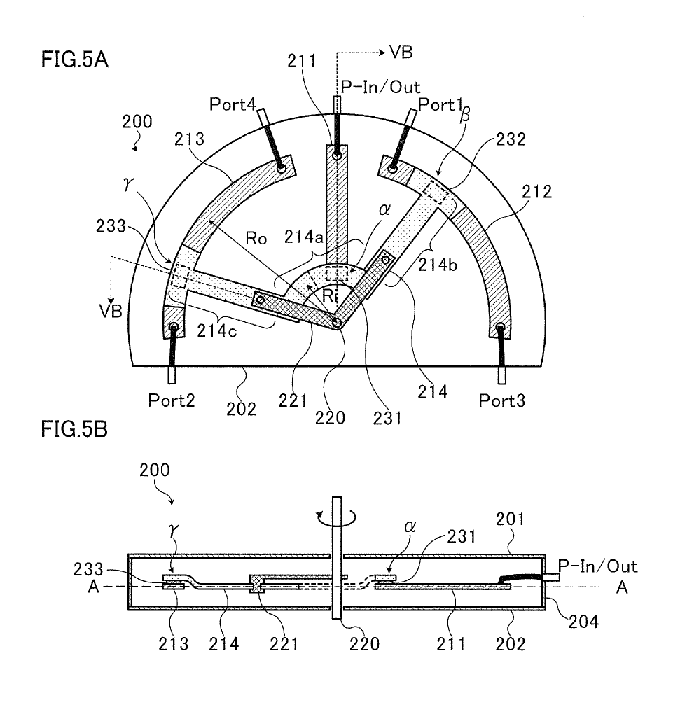

FIG. 5 is diagrams illustrating the inside of the phase shifter 200 in the first exemplary embodiment. FIG. 5A is a view illustrating the phase shifter 200 where the plate member 201 has been removed, and FIG. 5B is a view illustrating a cross section taken along a line VB-VB of FIG. 5A.

First, the planar shape of the inside of the phase shifter 200 will be described in FIG. 5A. The phase shifter 200 includes a linear conductor 211, curving conductors 212 and 213 each of which is formed into an arc of a radius Ro as one example of a first curvature radius, and a conductor 214 containing a curving portion 214a formed into an arc of a radius Ri as one example of a second curvature radius and extending portions 214b and 214c linearly extending from both ends of the curving portion 214a, in the inside covered by the plate members 201 and 202 and the side-surface members 203 and 204.

Note that the radius Ro is the distance from the center (rotation axis 220) to the middle of the width of each of the conductor 212 and the conductor 213. In the same manner, the radius Ri is the distance from the center (rotation axis 220) to the middle of the width of the curving portion 214a of the conductor 214. That is, the conductors 212 and 213 and the curving portion 214a of the conductor 214 form parts of concentric circles having the same center (rotation axis 220).

Here, the conductor 212 is one example of a first conductor, the conductor 214 is one example of a second conductor, and the conductor 211 is one example of a third conductor.

Each of these conductors 211, 212, 213 and 214 is made of a conductive material having high conductivity such as copper or aluminum, and the width thereof is 10 mm and the thickness thereof is 1 mm, for example.

Each of the arc-shaped conductors 212 and 213 of the radius Ro has the central angle of 80° and the radius Ro of 75 mm, for example. The curving portion 214a of the conductor 214, which is curved to form an arc of the radius Ri, has the central angle of 100° and the radius Ri of 25 mm, for example. Here, the radius Ri:the radius Ro is set at 1:3, as one example.

The conductors 212 and 213 curved to form respective arcs of the radius Ro are placed so as not to overlap with each other, and the linear conductor 211 is placed between the conductors 212 and 213. The linear conductor 211 is disposed in the radius direction of the circle of the radius Ro. Note that the conductor 211 does not overlap with the center (rotation axis 220).

The conductor 214 is configured to rotate about the center (rotation axis 220) towards the conductors 211, 212 and 213. Note that, since the conductor 214 does not overlap (intersect) with the rotation axis 220, the conductor 214 is fixed to the rotation axis 220 through a holding member 221 made of an insulating material (dielectric material) providing electrical insulation.

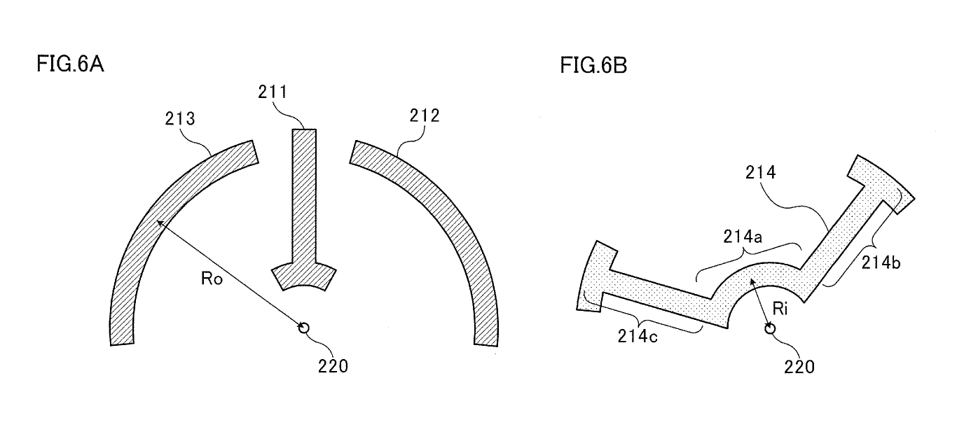

The linear conductor 211 has one end connected to the P-In/Out, and the other end overlapping (intersecting) with the curving portion 214a of the conductor 214. The other end of the conductor 211 is wider in the width direction, at a part α overlapping with the curving portion 214a of the conductor 214 (refer to later-described FIG. 6A). A spacer 231 which is a dielectric layer is interposed in the part α where the conductor 211 and the curving portion 214a of the conductor 214 overlap with each other, as shown in FIG. 5B.

In other words, the conductor 211 and the conductor 214 are configured to be capacitively coupled with each other through the spacer 231 at the part α where the conductor 211 and the curving portion 214a of the conductor 214 overlap with each other.

One end of the conductor 212 curved to form the arc of the radius Ro is connected to the port 1, and the other end is connected to the port 3. One end of the conductor 213 curved to form the arc of the radius Ro is connected to the port 2, and the other end is connected to the port 4.

Each of the ends of the extending portions 214b and 214c linearly extending from the both ends of the curving portion 214a of the conductor 214, overlaps (intersects) with corresponding one of the conductors 212 and 213.

The end of the extending portion 214b is wider in the width direction at a part β where the extending portion 214b of the conductor 214 and the conductor 212 overlap with each other. A spacer 232 which is a dielectric layer is interposed in the part β where the extending portion 214b of the conductor 214 and the conductor 212 overlap with each other. Thereby, the conductor 214 and the conductor 212 are configured to be capacitively coupled with each other through the spacer 232 at the part β where the extending portion 214b of the conductor 214 and the conductor 212 overlap with each other.

Similarly, the end of the extending portion 214c is wider in the width direction at a part γ where the extending portion 214c of the conductor 214 and the conductor 213 overlap with each other. A spacer 233 which is a dielectric layer is interposed in the part γ where the extending portion 214c of the conductor 214 and the conductor 213 overlap with each other. Thereby, the conductor 214 and the conductor 213 are configured to be capacitively coupled with each other through the spacer 233 at the part γ where the extending portion 214c of the conductor 214 and the conductor 213 overlap with each other.

The degree of the coupling (capacitive coupling) for the transmission/reception signals is increased by making the other end of the conductor 211 and the ends of the extending portions 214b and 214c of the conductor 214 wider in the width direction. However, the other end of the conductor 211 and the ends of the extending portions 214b and 214c of the conductor 214 may not be wider in the width direction in some cases.

The spacers 231, 232 and 233 are made of an insulating material (dielectric material) with low loss at high frequencies, such as polytetrafluoroethylene. The spacers 231, 232 and 233 reduce the friction with the conductors 211, 212 and 213, and facilitate sliding in the case where the conductor 214 is rotated.

Note that air layer may be acceptable instead of the spacers 231, 232 and 233 as the dielectric layers.

Instead of rotating the conductor 214, the conductors 211, 212 and 213 may be rotated. As long as the conductor 214 and the conductors 211, 212 and 213 are relatively movable, any configuration is acceptable.

Next, the cross section of the phase shifter 200 will be described in FIG. 5B. The cross section shown in FIG. 5B is the cross section taken along the line VB-VB in FIG. 5A, and the cross section of the conductor 214 (extending portion 214c) and the cross section of the conductor 211 are shown.

In the phase shifter 200, the conductors 211, 213 and 214 are interposed between the plate members 201 and 202 made of a conductive material, as shown in FIG. 5B.

The conductor 212 is also interposed therebetween although it is not shown in FIG. 5B. The plate members 201 and 202 have the same potential. In other words, the conductors 211, 212, 213 and 214 and the plate members 201 and 202 form a tri-plate line structure. Thus, the phase shifter 200 provides electromagnetic-wave protection so as to be insulated from the influence of electromagnetic noises, and is easily handled.

As mentioned above, the spacers 231, 232 and 233 which are the dielectric layers are interposed in the respective parts where any of the conductors 211, 212 and 213 and the conductor 214 overlap with each other. However, the conductors 211, 212, 213 and 214 are not formed on the substrate of an insulating material (dielectric material) such as glass epoxy.

In other words, since the space enclosed by the plate members 201 and 202 and the side-surface members 203 and 204 is filled with air, occurrence of dielectric loss (tan δ) is reduced at high frequencies representing transmission/reception signals passing thorough the conductors 211, 212, 213 and 214.

Note that the conductors 211, 212 and 213 are fixed to the plate members 201 and 202 by providing spacers (not shown in the figure). The conductor 214 is fixed to the rotation axis 220 through the holding member 221 as mentioned above.

The rotation axis 220 extends to the outside of the space enclosed by the plate members 201 and 202 and the side-surface members 203 and 204, through the hole provided in the plate member 201.

The conductor 214 is rotated about the rotation axis 220 by the rotation of the rotation axis 220, and, accordingly, the position of the part α where the curving portion 214a of the conductor 214 and the conductor 211 overlap with each other moves along the curving portion 214a, the position of the part β where the extending portion 214b of the conductor 214 and the conductor 212 overlap with each other moves along the conductor 212, and the position of the part γ where the extending portion 214c of the conductor 214 and the conductor 213 overlap with each other moves along the conductor 213. Thereby, the phase (phase shift amount) of the transmission/reception signal varies between the ports 1, 2, 3 and 4.

At this time, moving distance of the position of the part α where the curving portion 214a of the conductor 214 and the conductor 211 overlap with each other moving along the curving portion 214a and the moving distance of the position of the part β where the extending portion 214b of the conductor 214 and the conductor 212 overlap with each other moving along the conductor 212 are set to have a predetermined ratio. That is, they are set by using the radius Ri and the radius Ro.

Note that the conductors 211, 212, 213 and 214 are disposed within a plane parallel to the plate members 201 and 202 (plane shown by a line A-A in FIG. 5B) except for the overlapping parts α, β and γ. Thereby, variation in impedance occurring at the rotation of the conductor 214 about the rotation axis 220 is reduced.

FIG. 6 is diagrams illustrating the conductors 211, 212, 213 and 214 taken from the phase shifter 200. FIG. 6A shows the fixed conductors 211, 212 and 213, and FIG. 6B shows the rotatable conductor 214.

As shown in FIG. 6A, the linear conductor 211 and the conductors 212 and 213 curved to form the arcs of the radius Ro are disposed so as not to overlap with each other. As shown in FIG. 6B, the conductor 214 is formed by the curving portion 214a curved to form the arc of the radius Ri and the extending portions 214b and 214c linearly extending from the both ends of the curving portion 214a.

Thus, the phase shifter 200 in the first exemplary embodiment has a structure that is easily assembled, and exhibits excellent mass productivity.

Note that the angle between the extending portion 214b and the extending portion 214c of the conductor 214 is preferably set so that the extending portion 214c is located on the middle part of the conductor 213 (the intermediate position between the end where the port 2 is connected and the end where the port 4 is connected) when the extending portion 214b is located on the middle part of the conductor 212 (the intermediate position between the end where the port 1 is connected and the end where the port 3 is connected). If the conductor 212 and the conductor 213 are bilaterally symmetric on the paper surface of FIG. 5, there is no difference in the phase shift amount between the port 1 to port 4 in this state.

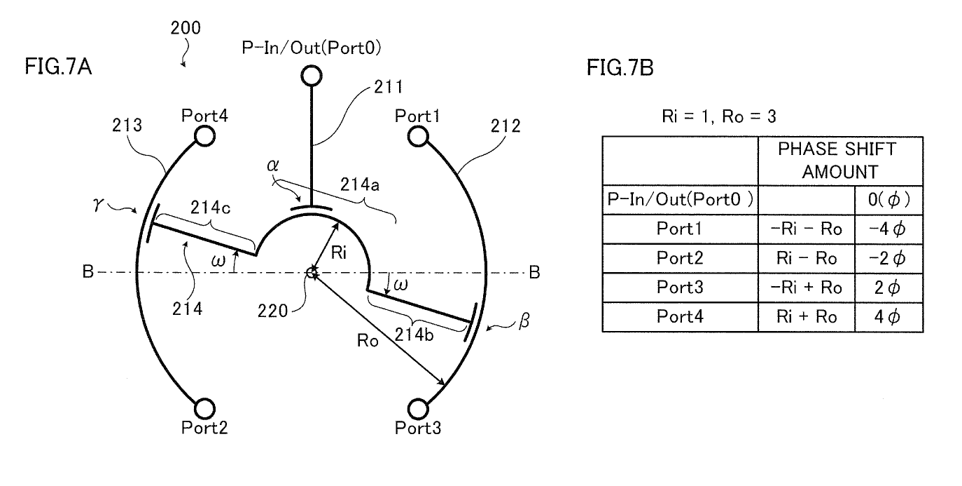

FIG. 7 is diagrams for describing the phase shift amounts of the phase shifter 200 in the case where the radius Ri:the radius Ro is 1:3. FIG. 7A shows the equivalent circuit of the phase shifter 200, and FIG. 7B is a table showing the phase shift amounts. Here, the description will be given on the assumption that radio frequencies are transmitted.

To provide an easier understanding, the angle between the extending portion 214b and the extending portion 214c of the conductor 214 in the phase shifter 200 shown in FIG. 5 is increased to be 180° in FIG. 7A. Accordingly, the extending portion 214b and the extending portion 214c of the conductor 214 are located on one straight line, and each of the conductor 212 and the conductor 213 are symmetric about a line B-B. Further, in FIG. 7A, an angle ω between the line B-B and each of the extending portion 214b and the extending portion 214c of the conductor 214 is set to be positive in the clockwise direction.

Note that the angle ω is regarded as negative in the counterclockwise direction.

The description will be given for the routes of the transmission signal input to the P-In/Out and propagation to the ports 1 to 4.

The transmission signal input to the P-In/Out is input to the conductor 214 via the part α where the conductor 211 and the curving portion 214a of the conductor 214 overlap with each other, after passing through the conductor 211. The transmission signal propagation to the right side of the conductor 214 in FIG. 7A passes through the extending portion 214b of the conductor 214. Then, the transmission signal is input to the conductor 212 via the part β where the extending portion 214b of the conductor 214 and the conductor 212 overlap with each other. Thereafter, the transmission signal input to the conductor 212 propagates to the upper side of the conductor 212 in FIG. 7A, and reaches the port 1. Meanwhile, the transmission signal input to the conductor 212 propagates to the lower side of the conductor 212 in FIG. 7A, and reaches the port 3.

On the other hand, the transmission signal propagation to the left side of the conductor 214 in FIG. 7A passes through the extending portion 214c of the conductor 214. Then, the transmission signal is input to the conductor 213 via the part γ where the extending portion 214c of the conductor 214 and the conductor 213 overlap with each other. Thereafter, the transmission signal input to the conductor 213 propagates to the upper side of the conductor 213 in FIG. 7A. Then, the transmission signal reaches the port 4. Meanwhile, the transmission signal input to the conductor 213 propagates to the lower side of the conductor 213 in FIG. 7A. Then, the transmission signal reaches the port 2.

In the case where the angle ω (radian) is “zero,” the extending portion 214b and the extending portion 214c of the conductor 214 are located on the line B-B in FIG. 7A. The transmission signal input to the P-In/Out then goes through the routes with the same length to reach the port 1 to port 4. Accordingly, there is no difference in the phase shift amount between the ports 1 to 4.

Next, description will be given in the case where the extending portion 214b and the extending portion 214c of the conductor 214 are located to form an angle ω with the line B-B, as shown in FIG. 7A. Note that, in this case, the transmission signals appearing at the port 1 to port 4 will be described on the assumption that the angle ω of “zero” is regarded as a “standard.” Here, the transmission signal is represented by a complex number in a sine wave, and the description will be given by focusing the part indicating the phase (index part).

First, the port 1 is described. Since the extending portion 214b is located to form the angle ω with the line B-B, the transmission signal propagates longer than the “standard” by (ω×Ri) in the curving portion 214a. The delay of the phase caused by this is 2π×(ω×Ri)/λg. Further, the transmission signal propagates longer than the “standard” by (ω×Ro) in the conductor 212. The delay of the phase caused by this is 2π×(ω×Ro)/λg. Thus, the transmission signal at the port 1 is expressed by an equation (1).

Note that λg is the wavelength of the transmission signal passing through the conductors 211, 212, 213 and 214 of the phase shifter 200.

Next, the phase shift amount for the port 2 will be described. The transmission signal propagates shorter than the “standard” by (ω×Ri) in the curving portion 214a. The advance of the phase caused by this is 2π×(ω×Ri)/λg. Further, the transmission signal propagates longer than the “standard” by (ω×Ro) in the conductor 213. The delay of the phase caused by this is 2π×(ω×Ro)/λg. Thus, the transmission signal at the port 2 is expressed by an equation (2).

Further, the transmission signal propagates longer than the standard by (ω×Ri) in the curving portion 214a, and shorter than the “standard” by (ω×Ro) in the conductor 212, to reach the port 3. Thus, the transmission signal at the port 3 is expressed by an equation (3).

Further, the transmission signal propagates shorter than the “standard” by (ω×Ri) in the curving portion 214a, and shorter than the “standard” by (ω×Ro) in the conductor 213, to reach the port 4. Thus, the transmission signal at the port 4 is expressed by an equation (4).

$$\begin{matrix}Port 1 {e}^{j ( - 2 π \times \frac{Ri \times ω}{λ g} - 2 π \times \frac{Ro \times ω}{λ g} )} = {e}^{j \frac{2 π}{λ g} ( - Ri - Ro ) ω} & Equation ( 1 ) \\ Port 2 {e}^{j ( 2 π \times \frac{Ri \times ω}{λ g} - 2 π \times \frac{Ro \times ω}{λ g} )} = {e}^{j \frac{2 π}{λ g} ( Ri - Ro ) ω} & Equation ( 2 ) \\ Port 3 {e}^{j ( - 2 π \times \frac{Ri \times ω}{λ g } + 2 π \times \frac{Ro \times ω}{λ g} )} = {e}^{j \frac{2 π}{λ g} ( - Ri + Ro ) ω} & Equation ( 3 ) \\ Port 4 {e}^{j ( 2 π \times \frac{Ri \times ω}{λ g} + 2 π \times \frac{Ro \times ω}{λ g} )} = {e}^{j \frac{2 π}{λ g} ( Ri + Ro ) ω} & Equation ( 4 )\end{matrix}$$

In the case of the radius Ri:the radius Ro=1:3, the transmission signals at the port 1 to the port 4 are expressed by equations (5) to (8), respectively. Here, 2π/λg·Ri·ω=φ is set. Thus, the difference in the phase shift amount between the port 1 and 2 and between the port 3 and port 4 is 2φ, while the difference in the phase shift amount between the port 2 and the port 3 is 4φ.

$$\begin{matrix}Port 1 {e}^{j \frac{2 π}{λ g} ( - 4 Ri ) ω} = {e}^{j ( - 4 φ )} & Equation ( 5 ) \\ Port 2 {e}^{j \frac{2 π}{λ g} ( - 2 Ri ) ω} = {e}^{j ( - 2 φ )} & Equation ( 6 ) \\ Port 3 {e}^{j \frac{2 π}{λ g} ( 2 Ri ) ω} = {e}^{j ( 2 φ )} & Equation ( 7 ) \\ Port 4 {e}^{j \frac{2 π}{λ g} ( 4 Ri ) ω} = {e}^{j ( 4 φ )} & Equation ( 8 )\end{matrix}$$

Here, the transmission signal transmitted from the transceiver unit 4 is divided by the divider 300, and the port 0 of the divider 300 is placed between the port 2 and the port 3 so that the transmission signal from the port 0 has the phase shift amount of “zero,” as shown in FIG. 3. By this configuration, the difference in the phase shift amount between the adjacent ports becomes 2φ, as shown in FIG. 7B.

Thereby, the difference in the phase shift amount between the adjacent dipole antennas 110 is set at a predetermined value in the array antenna 100 in which the five dipole antennas 110 are arrayed at equal intervals (refer to the interval Dp in FIG. 2), and the beam tilt angle θ of the sector antenna 10 is controllable.

Note that the phases at the ports vary depending on rotation of the rotation axis 220 causing the variations of the positions of the part α where the conductor 211 and the curving portion 214a of the conductor 214 overlap with each other, the part β where the extending portion 214b of the conductor 214 and the conductor 212 overlap with each other, and the part γ where the extending portion 214c of the conductor 214 and the conductor 213 overlap with each other. Thus, the beam tilt angle θ of the sector antenna 10 is adjustable (variable).

The rotation axis 220 may be rotated by hand, or be electrically rotated by providing a motor. In the case where the rotation axis 220 is rotated by the motor, the rotation may be performed by providing a controller on the outside of the sector antenna 10 and transmitting a control signals for controlling the rotation angle of the rotation axis 220 rotated by the motor.

In the above description, the combination of the divider 300 and the phase shifter 200 enables the difference in the phase shift amount between plural transmission signals to be provided to the array antenna 100 to be set at the predetermined difference in the phase shift amount between the adjacent ports. As an example of this case, the radius Ri:the radius Ro=1:3 is set as shown in FIG. 7B.

In the phase shifter 200 shown in FIG. 5, the radius Ri:the radius Ro can be set at a ratio other than 1:3.

Next, as one different example of the radius Ri:the radius Ro, the case of the radius Ri:the radius Ro=1:2 will be described. In this case, the phase difference between the plural transmission signals to be provided to the array antenna 100 can be set at the predetermined difference in the phase shift amount between the adjacent ports, by using the phase shifter 200 and without using the divider 300.

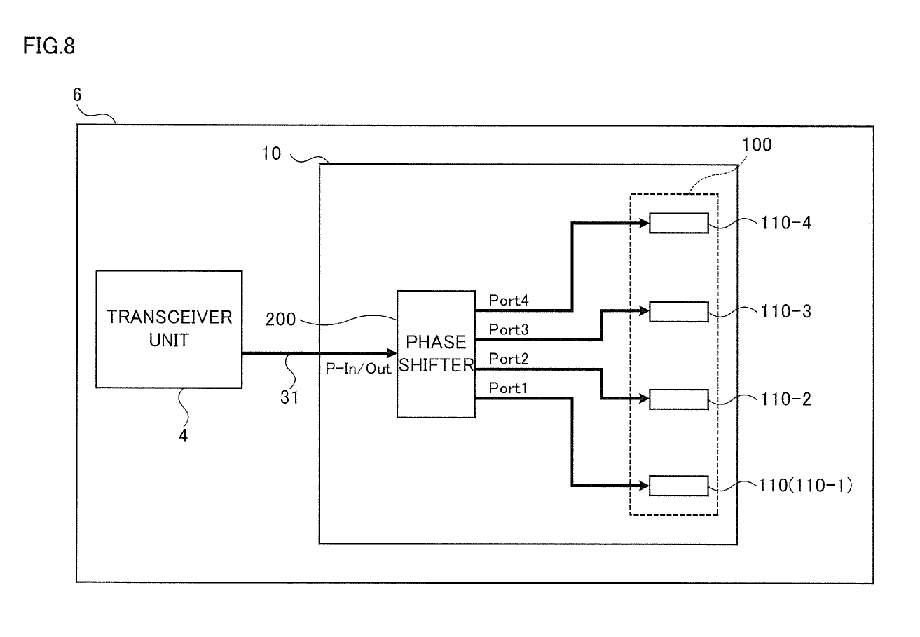

FIG. 8 is a diagram showing the relation of the connection between the array antenna 100 and the phase shifter 200.

Here, the description will be given on the assumption that the array antenna 100 includes four dipole antennas 110 (110-1, 110-2, . . . to 110-4).

The phase shifter 200 includes the P-In/Out and the four ports 1 to 4. The P-In/Out is connected to the transceiver unit 4. The port 1 is connected to the dipole antenna 110-1, the port 2 is connected to the dipole antenna 110-2, the port 3 is connected to the dipole antenna 110-3, and the port 4 is connected to the dipole antenna 110-4. In other words, the divider 300 is not provided, and the transmission signal from the transceiver unit 4 is input to the P-In/Out of the phase shifter 200.

Note that, in FIG. 8, each of the ports 1 to 4 of the phase shifter 200 is connected to corresponding one of the dipole antennas 110, in FIG. 8. However, each of the ports 1 to 4 of the phase shifter 200 may be connected to corresponding one of groups each of which includes plural dipole antennas 110. In this case, the dipole antennas 110-1 to 110-4 in FIG. 8 may be replaced with the groups of the dipole antennas 110.

The phase shifter 200 has the same configuration as the illustration in FIGS. 4 and 5. However, the radius Ri:the radius Ro=1:2 is set.

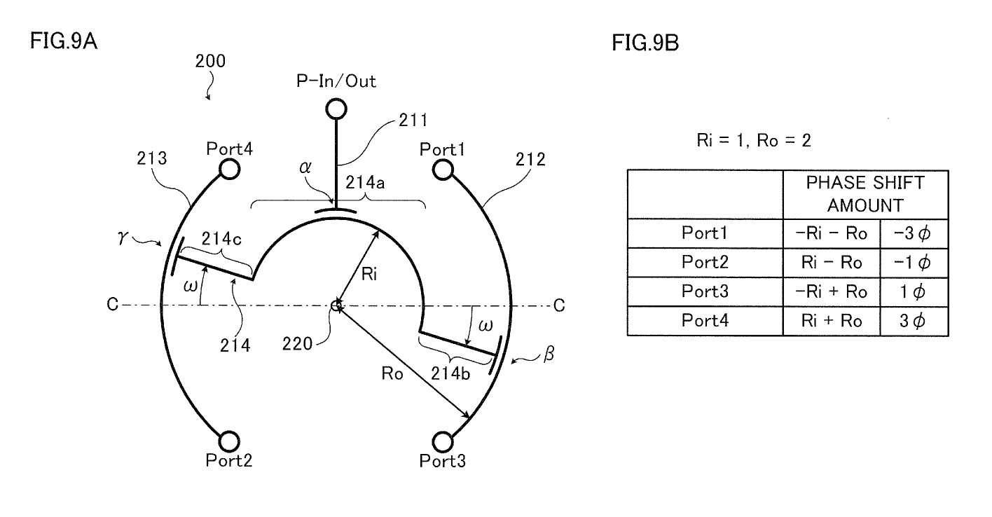

FIG. 9 is diagrams for describing the phase shift amount of the phase shifter 200 in the case of the radius Ri:the radius Ro=1:2. FIG. 9A shows the equivalent circuit of the phase shifter 200, and FIG. 9B is a table showing the phase shift amount. Here, the description will be given on the assumption that radio frequencies are transmitted.

In the case of the radius Ri:the radius Ro=1:2, the equation φ to the equation (4) are replaced with the equation (9) to the equation (12), respectively. Here, 2π/λg·Ri·ω=φ is set. Thus, all of the differences in the phase shift amounts between the port 1 and the port 2, between the port 2 and the port 3, and between the port 3 and port 4 are 2φ.

$$\begin{matrix}Port 1 {e}^{j \frac{2 π}{λ g} ( - 3 Ri ) ω} = {e}^{j ( - 3 φ )} & Equation ( 9 ) \\ Port 2 {e}^{j \frac{2 π}{λ g} ( - Ri ) ω} = {e}^{j ( - φ )} & Equation ( 10 ) \\ Port 3 {e}^{j \frac{2 π}{λ g} ( Ri ) ω} = {e}^{j ( φ )} & Equation ( 11 ) \\ Port 4 {e}^{j \frac{2 π}{λ g} ( 3 Ri ) ω} = {e}^{j ( 3 φ )} & Equation ( 12 )\end{matrix}$$

Accordingly, in the case of the radius Ri:the radius Ro=1:2, the transmission signal from the port 0 of the divider 300, which has the phase shift amount of “zero,” is not necessary unlike in the case of the radius Ri:the radius Ro=1:3.

In other words, if the transmission signals of the port 1 to the port 4 are provided to the array antenna 100 including the four dipole antennas 110-1, 110-2, 110-3 and 110-4, the phase shift amount between the adjacent dipole antennas 110 is set at a predetermined value in the array antenna 100 in which the adjacent four dipole antennas 110 are arrayed at equal intervals (refer to the interval Dp in FIG. 2), and thereby the beam tilt angle θ of the sector antenna 10 is controllable.

Note that, depending on the rotation of the rotation axis 220 causing the variations of the positions of the part α where the conductor 211 and the curving portion 214a of the conductor 214 overlap with each other, the part β where the extending portion 214b of the conductor 214 and the conductor 212 overlap with each other, and the part γ where the extending portion 214c of the conductor 214 and the conductor 213 overlap with each other, the phases at the port 1 to the port 4 vary. Thus, the beam tilt angle θ of the sector antenna 10 is adjustable (variable).

As described above, in the first exemplary embodiment, the setting of the radius Ri:the radius Ro allows the difference between the phases at the ports of the phase shifter 200 and the port 0 of the divider 300 to be set at the predetermined difference in the case of providing the divider 300, and the difference between the phases at the ports of the phase shifter 200 to be set at the predetermined difference without using the divider 300.

Note that the radius Ri:the radius Ro may not be a ratio of integers, and may be a ratio involving decimals.

### Second Exemplary Embodiment

In the first exemplary embodiment, the phase shifter 200 includes the four ports 1, 2, 3 and 4. In this case, the transmission signals having different phases can be transmitted to the respective five dipole antennas 110 or the respective five groups of the dipole antennas 110 by combining the phase shifter 200 with the divider 300. In addition, the reception signals of the five dipole antennas 110 or the five groups of the dipole antennas 110 can be synthesized while the phases thereof are varied.

Further, the transmission signals having different phases can be transmitted to the respective four dipole antennas 110 or the respective four groups of the dipole antennas 110 by using only the phase shifter 200. In addition, the reception signals of the four dipole antennas 110 or the four groups of the dipole antennas 110 can be synthesized while the phases thereof are varied.

In the second exemplary embodiment, the phase shifter 200 includes eight ports 1, 2, 3, 4, 5, 6, 7 and 8. Thus, the transmission signals having different phases can be transmitted to the respective dipole antennas 110 up to nine or the respective groups up to nine, each of which includes the dipole antennas 110, by combining the phase shifter 200 with the divider 300. In addition, the reception signals of the dipole antennas 110 up to nine or the groups up to nine, each of which includes the dipole antennas 110, can be synthesized while the phases thereof are varied.

Further, the transmission signals having different phases can be transmitted to the respective eight dipole antennas 110 or the respective eight groups of the dipole antennas 110 by using only the phase shifter 200. In addition, the reception signals of the eight dipole antennas 110 or the eight groups of the dipole antennas 110 can be synthesized while the phases thereof are varied.

The other configurations are the same as the first exemplary embodiment. Thus, the same reference numerals are used for the same parts, the description thereof is omitted, and the different parts will be described.

### <Phase Shifter 200>

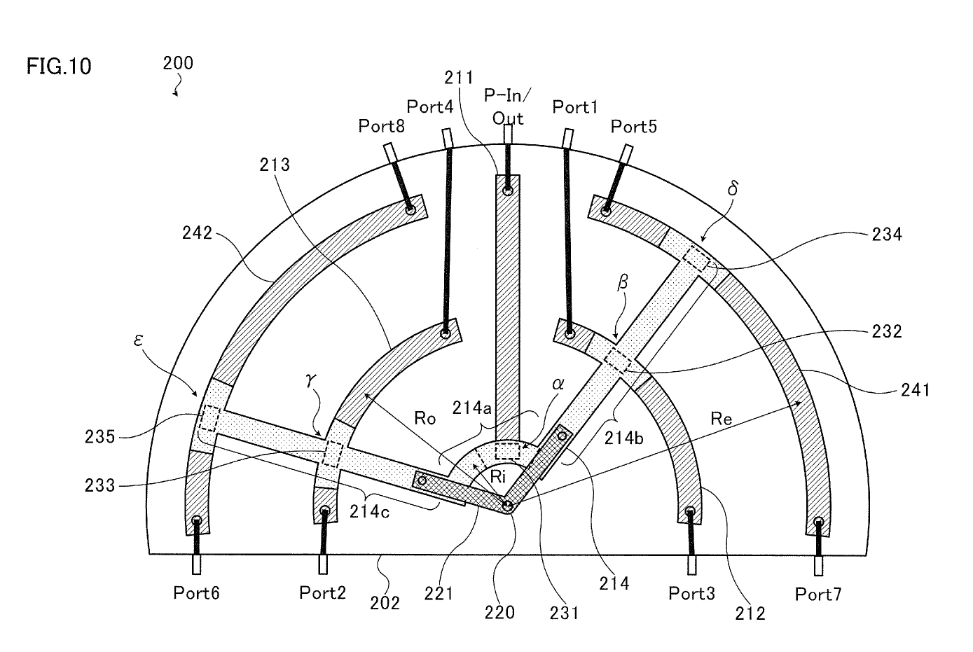

FIG. 10 is a diagram illustrating the inside of the phase shifter 200 in the second exemplary embodiment. Similarly to FIG. 5A, the inside of the phase shifter 200 is shown by removing the plate member 201.

The phase shifter 200 further includes conductors 241 and 242 curved to form arcs of the radius Re on the outside of the conductors 212 and 213 that are curved to form the arcs of the radius Ro and are shown in the phase shifter 200 of FIG. 5A in the first exemplary embodiment. The conductors 241 and 242 are fixed in a manner similar to the conductors 212 and 213. The both ends of the conductor 241 are connected to the respective ports 5 and 7, and the both ends of the conductor 242 are connected to the respective ports 6 and 8.

Each of the extending portions 214b and 214c of the conductor 214 extends to overlap with the corresponding one of the conductors 241 and 242. A spacer 234 which is a dielectric layer is interposed in a part 8 where the extending portion 214b of the conductor 214 and the conductor 241 overlap with each other. A spacer 235 which is a dielectric layer is interposed in a part E where the extending portion 214c of the conductor 214 and the conductor 242 overlap with each other.

Note that air layer may be provided instead of the spacers 234 and 235 as the dielectric layers.

The phase shifter 200 includes the P-In/Out and the port 1 to the port 8, as input-output terminals. Each of the port 1 to the port 8 is one example of a first input-output terminal, and the P-In/Out is one example of a second input-output terminal.

By the above configuration, the transmission signal input to the P-In/Out of the phase shifter 200 is configured to be output, as transmission signals having different phases, from the eight ports 1 to 8. In the same manner, the reception signals input to the eight ports 1 to 8 are synthesized while the phases thereof are adjusted, and the resultant signal can be output from the P-In/Out.

Depending on the setting of the radii Ri, Ro and Re, the transmission signals having the predetermined difference in the phase shift amount can be transmitted to the dipole antennas 110 up to nine or the groups up to nine, each of which includes the dipole antennas 110, if the port 1 to the port 8 of the phase shifter 200 and the port 0 of the divider 300 are combined. Further, depending on the setting of the radii Ri, Ro and Re, the transmission signals having the predetermined difference in the phase shift amount can be transmitted to the eight dipole antennas 110 or the eight groups each of which includes the dipole antennas 110 if only the phase shifter 200 is used.

The difference in the phase shift amount between the ports may be set on the basis of the lengths (center angles) of the conductors 212, 213, 241 and 242, the length (center angle) of the curving portion 214a of the conductor 214, the wavelength of the radio frequencies to be transmitted or received, and the like.

In a similar manner, if curving conductors are further provided on the outside of the conductors 241 and 242 of the phase shifter 200, the number of the ports can be further increased.

### Third Exemplary Embodiment

The base-station antenna 1 in each of the first exemplary embodiment and the second exemplary embodiment includes plural sector antennas 10 (10-1 to 10-3) having radiation pattern. The base-station antenna 1 in the third exemplary embodiment includes an omni antenna 50 having omnidirectivity. Note that the base-station antenna 1 in the third exemplary embodiment may include one omni antenna 50 or plural omni antennas 50.

The other configurations are the same as the first exemplary embodiment. Thus, the same reference numerals are used for the same parts, the description thereof is omitted, and the different parts will be described.

### <Omni Antenna 50>

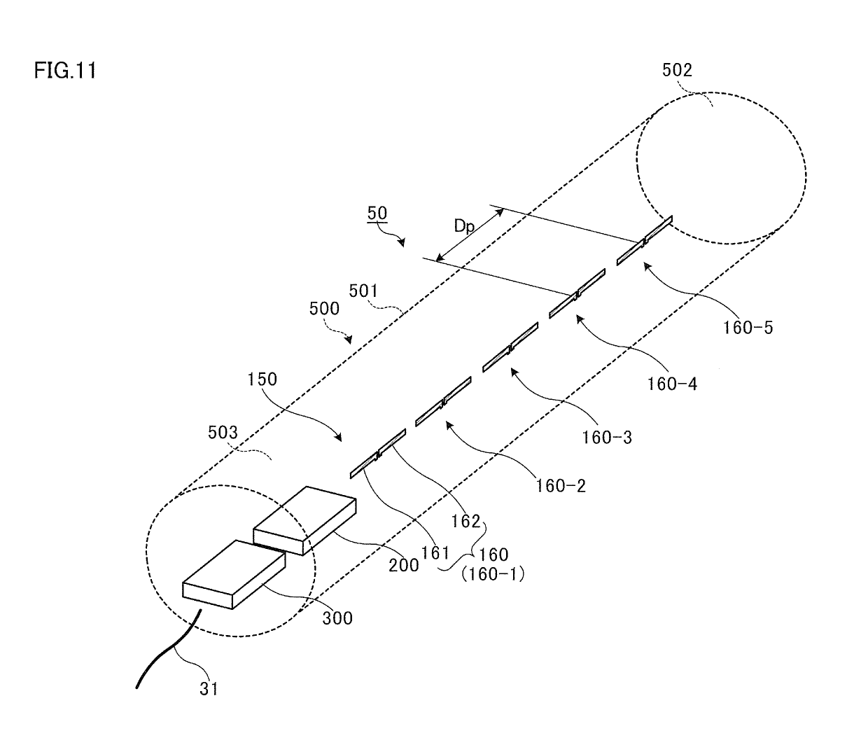

FIG. 11 is a diagram illustrating one example of the configuration of the omni antenna 50 in the third exemplary embodiment. FIG. 10 is a perspective view of the one omni antenna 50 that has been laterally placed.

The omni antenna 50 includes an array antenna 150 containing plural antenna elements arrayed at the intervals Dp, the phase shifter 200, the divider 300, and the radome 500 provided so as to surround the array antenna 150, the phase shifter 200 and the divider 300. In FIG. 11, the radome 500 is illustrated with broken lines, so that the array antenna 150 provided inside the radome 500 can be seen.

Hereinafter, description will be given in a case where dipole antennas are regarded as one example of the antenna elements.

The array antenna 150 includes dipole antennas 160-1 to 160-5. In the case where the dipole antennas 160-1 to 160-5 are not discriminated, they are expressed as the dipole antennas 160.

Each of the dipole antennas 160 includes linear elements 161 and 162 arrayed in line.

The section where the element 161 and the element 162 face each other is a feeding point.

Each of the elements 161 and 162 is made of a conductor such as copper or aluminum on the front surface side of an insulating substrate (not shown) such as an epoxy resin.

The dipole antennas 160 shown in FIG. 11 can transmit and receive polarizations (vertical polarization) having the electric field oscillating in the vertical direction towards the ground.

The array antenna 150 does not include the reflector 120 unlike the array antenna 100 shown in FIG. 2 in the first exemplary embodiment. Thus, the array antenna 150 enables radio frequencies to be transmitted or received at every angle up to 360° within the horizontal surface.

The phase shifter 200 and the divider 300 are the same as those of the first exemplary embodiment. Thus, the radius Ri:the radius Ro=1:3 is set in the phase shifter 200 shown in FIG. 5, the port 1 of the phase shifter 200 is connected to the dipole antenna 160-1, the port 2 is connected to the dipole antenna 160-2, the port 3 is connected to the dipole antenna 160-4, the port 4 is connected to the dipole antenna 160-5, the port 0 of the divider 300 is connected to the dipole antenna 160-3, and thereby the difference in the phase shift amount between the adjacent dipole antennas 160 can be set at a predetermined value similarly to the sector antenna 10 in the first exemplary embodiment. Thereby, the beam tilt angle θ of the omni antenna 50 is controllable.

Similarly to FIG. 8 shown in the first exemplary embodiment, in the omni antenna 50 containing the four dipole antennas 160-1, 160-2, 160-3 and 160-4, the radius Ri:the radius Ro=1:2 is set in the phase shifter 200 shown in FIG. 5, the port 1 of the phase shifter 200 is connected to the dipole antenna 160-1, the port 2 is connected to the dipole antenna 160-2, the port 3 is connected to the dipole antenna 160-3, the port 4 is connected to the dipole antenna 160-4, and thereby the difference in the phase shift amount between the adjacent dipole antennas 160 can be set at a predetermined value similarly to the case shown in FIG. 8 in the first exemplary embodiment. Thereby, the beam tilt angle θ of the omni antenna 50 is controllable.

Note that the radius Ri:the radius Ro may not be a ratio of integers, and may be a ratio involving decimals.

Although the sector antenna 10 contains the antenna elements (dipole antennas 110) forming dipoles in the first exemplary embodiment and the second exemplary embodiment, antenna elements different from the dipoles may be used.

Although the omni antenna 50 contains the antenna elements (dipole antennas 160) forming dipoles in the third exemplary embodiment, antenna elements different from the dipoles may be used.

### REFERENCE SIGNS LIST

1 . . . Base-station antenna
2 . . . Cell
3, 3-1 to 3-3 . . . Sector
4 . . . Transceiver unit
6 . . . Radio apparatus
10, 10-1 to 10-3 . . . Sector antenna
11 . . . Main lobe
20 . . . Tower
50 . . . Omni antenna
100, 150 . . . Array antenna
110, 110-1 to 110-5, 160, 160-1 to 160-5 . . . Dipole antenna
120 . . . Reflector
200 . . . Phase shifter
211, 212, 213, 214, 241, 242 . . . Conductor
220 . . . Rotation axis
300 . . . Divider
500 . . . Radome
θ . . . Beam tilt angle

1-8. (canceled)

9. A phase shifter comprising:
a first conductor that has a first curvature radius, that has one end connected to a first input-output terminal, and that is made of a conductive material;
a second conductor that comprises a curving portion of a second curvature radius smaller than the first curvature radius, and an extending portion extending from one end of the curving portion so as to be electrically coupled to the first conductor, that has a position relatively movable in the first conductor, the position being electrically coupled to the first conductor, and that is made of a conductive material; and
a third conductor that extends to have one end connected to a second input-output terminal and the other end electrically coupled to the curving portion of the second conductor, that has a position relatively movable in the curving portion, the position being electrically coupled to the second conductor, and that is made of a conductive material,
wherein the first conductor and the third conductor are fixed and the second conductor is movable towards the first conductor and the third conductor to set a phase shift amount.

10. The phase shifter according to claim 9, wherein a moving distance of the position where the first conductor and the extending portion of the second conductor are electrically coupled to each other in the first conductor and a moving distance of the position where the curving portion of the second conductor and the third conductor are electrically coupled to each other in the curving portion of the second conductor are set to have a predetermined ratio.

11. The phase shifter according to claim 9, wherein the first curvature radius and the second curvature radius are provided for a common center.

12. The phase shifter according to claim 10, wherein the first curvature radius and the second curvature radius are provided for a common center.

13. The phase shifter according to claim 9, further comprising:
a first plate member and a second plate member each of which is made of a conductive material,
wherein the first conductor, the second conductor, and the third conductor are provided between the first plate member and the second plate member, and
wherein any one of electrical coupling between the first conductor and the extending portion of the second conductor and electrical coupling between the curving portion of the second conductor and the third conductor is capacitive coupling where any one of a dielectric layer and air layer is interposed.

14. The phase shifter according to claim 10, further comprising:
a first plate member and a second plate member each of which is made of a conductive material,
wherein the first conductor, the second conductor, and the third conductor are provided between the first plate member and the second plate member, and
wherein any one of electrical coupling between the first conductor and the extending portion of the second conductor and electrical coupling between the curving portion of the second conductor and the third conductor is capacitive coupling where any one of a dielectric layer and air layer is interposed.

15. The phase shifter according to claim 11, further comprising:
a first plate member and a second plate member each of which is made of a conductive material,
wherein the first conductor, the second conductor, and the third conductor are provided between the first plate member and the second plate member, and
wherein any one of electrical coupling between the first conductor and the extending portion of the second conductor and electrical coupling between the curving portion of the second conductor and the third conductor is capacitive coupling where any one of a dielectric layer and air layer is interposed.

16. The phase shifter according to claim 12, further comprising:
a first plate member and a second plate member each of which is made of a conductive material,
wherein the first conductor, the second conductor, and the third conductor are provided between the first plate member and the second plate member, and
wherein any one of electrical coupling between the first conductor and the extending portion of the second conductor and electrical coupling between the curving portion of the second conductor and the third conductor is capacitive coupling where any one of a dielectric layer and air layer is interposed.

17. An antenna comprising:
a plurality of antenna elements; and
a phase shifter comprising a first conductor that has a first curvature radius, that has one end connected to a first input-output terminal, and that is made of a conductive material, a second conductor that comprises a curving portion of a second curvature radius smaller than the first curvature radius and an extending portion extending from one end of the curving portion so as to be electrically coupled to the first conductor, that has a position relatively movable in the first conductor, the position being electrically coupled to the first conductor, and that is made of a conductive material, and a third conductor that extends to have one end connected to a second input-output terminal and the other end electrically coupled to the curving portion of the second conductor, that has a position relatively movable in the curving portion, the position being electrically coupled to the second conductor, and that is made of a conductive material, the first input-output terminal being connected to any of the plurality of antenna elements,
wherein the first conductor and the third conductor of the phase shifter are fixed and the second conductor is movable towards the first conductor and the third conductor to set a phase shift amount.

18. A radio apparatus comprising:
a plurality of antenna elements;
a phase shifter comprising a first conductor that has a first curvature radius, that has one end connected to a first input-output terminal, and that is made of a conductive material, a second conductor that comprises a curving portion of a second curvature radius smaller than the first curvature radius, and an extending portion extending from one end of the curving portion so as to be electrically coupled to the first conductor, that has a position relatively movable in the first conductor, the position being electrically coupled to the first conductor, and that is made of a conductive material, and a third conductor that extends to have one end connected to a second input-output terminal and the other end electrically coupled to the curving portion of the second conductor, that has a position relatively movable in the curving portion, the position being electrically coupled to the second conductor, and that is made of a conductive material, the first input-output terminal being connected to any of the plurality of antenna elements; and
a transceiver unit that transmits a transmission signal to be transmitted by the plurality of antenna elements and receives a reception signal received by the plurality of the antenna elements,
wherein the first conductor and the third conductor are fixed and the second conductor is movable towards the first conductor and the third conductor to set a phase shift amount in the phase shifter.
